(19) United States
(12) Patent Application Publication
(10) Pub. No.: US 2026/0010465 A1
(43) Pub. Date: Jan. 8, 2026

(54) METHOD FOR GENERATING TEST CASE, ELECTRONIC DEVICE AND STORAGE MEDIUM

(71) Applicant: Beijing Baidu Netcom Science Technology Co., Ltd., Beijing (CN)

(72) Inventors: Xin Tian, Beijing (CN); Yang Yang, Beijing (CN); Siqi Bao, Beijing (CN); Yu Sun, Beijing (CN); Hua Wu, Beijing (CN)

(21) Appl. No.: 19/329,750

(22) Filed: Sep. 16, 2025

(30) Foreign Application Priority Data
Jun. 20, 2025 (CN) 2025108373263.8

(51) Int. Cl. G06F 11/3668

(52) U.S. Cl. CPC G06F 11/3684

(57) ABSTRACT

Provided are a method for generating a test case, an electronic device and a storage medium, relating to the field of data processing technology, and in particular to the fields of artificial intelligence, large model and other technologies. The method includes: obtaining test requirement information of code to be tested; calling the large model based on the test requirement information of the code to be tested to generate a target generator for the code to be tested; and obtaining a plurality of target test cases for testing the code to be tested based on the target generator.

### CROSS-REFERENCE TO RELATED APPLICATIONS

The present application claims priority to Chinese Patent Application No. CN202510837326.8, filed with the China National Intellectual Property Administration on Jun. 20, 2025, the disclosure of which is hereby incorporated herein by reference in its entirety.

### TECHNICAL FIELD

The present disclosure relates to the field of data processing technology, and in particular to the fields of artificial intelligence, large model and other technologies.

### BACKGROUND

The unit test of software is a key link to ensure the quality and stability of software. Traditional technologies for generating unit test cases mainly rely on manual writing and templates, but these methods usually have problems such as low generation efficiency and low test coverage, making it difficult to cope with complex and changing service scenarios. Therefore, how to efficiently generate unit test cases is a problem to be solved urgently at present.

### SUMMARY

The present disclosure provides a method and an apparatus for generating a test case, a device and a storage medium.

According to one aspect of the present disclosure, provided is a method for generating a test case based on a large model, including: obtaining test requirement information of code to be tested; calling the large model based on the test requirement information of the code to be tested to generate a target generator for the code to be tested; and obtaining a plurality of target test cases for testing the code to be tested based on the target generator.

According to another aspect of the present disclosure, provided is an apparatus for generating a test case based on a large model, including: a requirement obtaining unit configured to obtain test requirement information of code to be tested; and a case generation unit configured to call the large model based on the test requirement information of the code to be tested to generate a target generator for the code to be tested; and obtain a plurality of target test cases for testing the code to be tested based on the target generator.

According to yet another aspect of the present disclosure, provided is an electronic device, including: at least one processor; and a memory connected in communication with the at least one processor; where the memory stores an instruction executable by the at least one processor, and the instruction, when executed by the at least one processor, enables the at least one processor to execute the method of any example of the present disclosure.

According to yet another aspect of the present disclosure, provided is a non-transitory computer-readable storage medium storing a computer instruction thereon, and the computer instruction is used to cause a computer to execute the method according to any one of the examples of the present disclosure.

According to yet another aspect of the present disclosure, provided is a computer program product including a computer program, and the computer program implements the method according to any one of the examples of the present disclosure, when executed by a processor.

In this way, the solution of the present disclosure can utilize the large model in combination with the test requirement information to firstly generate a generator (corresponding to the above-mentioned target generator) and then use the generator to generate a plurality of target test cases required, thus realizing the automatic generation of test cases, saving the manpower and time costs required to generate test cases, then improving the generation efficiency of test cases, and thereby laying the foundation for subsequently meeting the rapid iteration requirement of software code.

It should be understood that the content described in this part is not intended to identify critical or essential features of examples of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a first schematic flowchart of a method for generating a test case based on a large model according to an example of the present application;

FIG. 2 is a second schematic flowchart of a method for generating a test case based on a large model according to an example of the present application;

FIG. 3 is a structural schematic diagram of an apparatus for generating a test case based on a large model according to an example of the present application; and

FIG. 4 is a block diagram of an electronic device used to implement the method for generating the test case based on the large model according to an example of the present application.

### DETAILED DESCRIPTION

Hereinafter, descriptions to exemplary examples of the present disclosure are made with reference to the accompanying drawings, include various details of the examples of the present disclosure to facilitate understanding, and should be considered as merely exemplary. Therefore, those having ordinary skill in the art should realize, various changes and modifications may be made to the examples described herein, without departing from the scope of the present disclosure. Likewise, for clarity and conciseness, descriptions of well-known functions and structures are omitted in the following descriptions.

The term “and/or” herein only describes an association relation of associated objects, which indicates that there may be three kinds of relations, for example, A and/or B may indicate that only A exists, or both A and B exist, or only B exists. The term “at least one” herein indicates any one of many items, or any combination of at least two of the many items, for example, at least one of A, B or C may indicate any one or more elements selected from a set of A, B and C. The terms “first” and “second” herein indicate a plurality of similar technical terms and distinguish them from each other, but do not limit an order of them or limit that there are only two items, for example, a first feature and a second feature indicate two types of features/two features, a quantity of the first feature may be one or more, and a quantity of the second feature may also be one or more.

In addition, in order to better illustrate the present disclosure, numerous specific details are given in the following specific implementations. Those having ordinary skill in the art should understand that the present disclosure may be performed without certain specific details. In some examples, methods, means, elements and circuits well known to those having ordinary skill in the art are not described in detail, in order to highlight the subject matter of the present disclosure.

The solution of the present disclosure provides a method for generating a test case based on a large model, in which the large model may be utilized to automatically generate a test case generator (corresponding to a target generator) according to the actual test requirement, and then the test case generator generates test cases required for the actual test. Here, the solution of the present disclosure effectively utilizes the reasoning advantage of the large model to firstly generate the above-mentioned generator and then use the generator to efficiently obtain the required test cases. Therefore, compared with manually writing test cases, the solution of the present disclosure realizes the automatic generation of test cases, saves a lot of manpower and time costs, and effectively improves the generation efficiency of test cases, which is of great significance to the continuous progress and constant iteration in the field of software code generation.

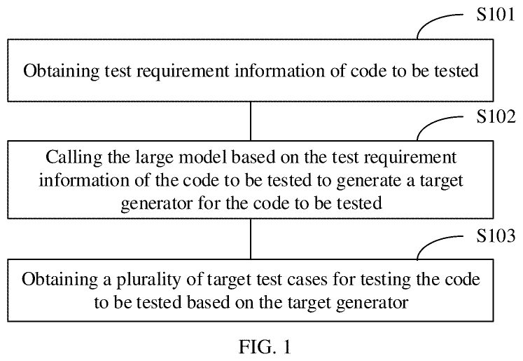

Specifically, FIG. 1 is a first schematic flowchart of a method for generating a test case based on a large model according to an example of the present application. This method is optionally applied in electronic devices, such as personal computers, servers, server clusters and other electronic devices.

Further, this method includes at least a part of the following content. As shown in FIG. 1, this method includes:

Step S101: obtaining test requirement information of code to be tested.

Here, in one example, the code to be tested may specifically be code required for the unit test, or may be code corresponding to the smallest unit or smallest functional module in a software program, etc., which is not specifically limited in the solution of the present disclosure.

Step S102: calling the large model based on the test requirement information of the code to be tested to generate a target generator for the code to be tested.

Step S103: obtaining a plurality of target test cases for testing the code to be tested based on the target generator.

In this way, the solution of the present disclosure can utilize the large model in combination with the test requirement information to firstly generate a generator (corresponding to the above-mentioned target generator) and then use the generator to generate a plurality of target test cases required, thus realizing the automatic generation of test cases, saving the manpower and time costs required to generate test cases, then improving the generation efficiency of test cases, and thereby laying the foundation for subsequently meeting the rapid iteration requirement of software code.

Moreover, since the large model of the solution of the present disclosure firstly generates the target generator according to the test requirement information and then uses the target generator to obtain the test cases required for the test, the solution of the present disclosure is more flexible, and in other words, can intelligently generate corresponding generators according to the actual test requirements of different service scenarios and then use the generators to automatically generate a plurality of test cases, thus effectively coping with complex and changeable service logic scenarios, and effectively avoiding the problem that the generated test cases do not conform to the actual service logic while effectively improving the test coverage.

Further, in a specific example, the amount of text data occupied by the target generator is less than the amount of text data occupied by a test case directly generated by the large model. Further, in a specific example, the number of tokens occupied by generating the target generator is less than the number of tokens occupied by the large model to directly generate the test case. Thus, compared with the solution of directly using the large model to generate test cases, the solution of the present disclosure occupies fewer resources, and for example, can effectively avoid the problem of not being able to efficiently obtain test cases meeting requirements due to the resource issue, and in other words, reduce the test cost and thereby facilitate large-scale engineering promotion.

Further, in a specific example, the test requirement information of the code to be tested may be obtained in the following manner; and specifically, the above-mentioned step of obtaining the test requirement information of the code to be tested (for example, step S101) may specifically include:

Step S101-1: parsing the code to be tested to obtain a target parsing result.

Here, the target parsing result includes at least one of the following code features:
a service feature of the code to be tested, a function feature of the code to be tested, and a path feature of an execution path of the code to be tested.

For example, in one example, before generating test cases, the comprehensive and in-depth syntax analysis and semantic parsing of the code to be tested may be performed to obtain the target parsing result as follows:

(1) The function feature of the code to be tested, such as the feature information in the dimension of function; specifically including but not limited to: the function information, the parameter type accepted by the function, the return value type of the function, and the calling dependency relationship between functions, etc.

(2) The path feature of the execution path of the code to be tested, such as the feature information in the dimensions of path and handling mechanism; specifically including but not limited to: execution path, logical branch, exception handling mechanism, etc.

(3) The service feature of the code to be tested, such as the feature information in the dimensions of service rule and service condition; specifically including but not limited to: key rule related to service logic, and clear boundary condition.

Step S101-2: obtaining the test requirement information matching a code feature represented by the target parsing result based on the target parsing result.

In this way, the solution of the present disclosure can obtain the test requirement information of the code to be tested according to the target parsing result of the code to be tested, and thus enable the generated generator to better meet the test requirement according to the rich information contained in the test requirement information, thereby improving the effectiveness and accuracy of the obtained test cases, and thus providing strong support for subsequent improvement of the test quality of the software code.

Further, in one example, the target generator obtained based on the above test requirement information has at least one of the following functions: function adaptation function (for example, dynamically adaptable function interface), service scenario adaptation function, and test case adaptation function.

For example, in one example, for the function adaptation function, the target generator can dynamically adapt to different function interfaces to intelligently generate a variety of test case combinations.

Further, in another example, for the service scenario adaptation function, the target generator can intelligently generate a combination of single test cases with high coverage and reliable quality according to the service feature of the code to be tested.

Further, in yet another example, for the test case adaptation function, the target generator can generate test cases based on the test constraint corresponding to the code to be tested, for example, intelligently generate test cases according to the boundary condition, service logic and exceptional situation, to ensure the authenticity of the test cases and their alignment with the service.

In this way, the test cases generated by the target generator described in the solution of the present disclosure can effectively improve the test efficiency of the code to be tested while improving the test coverage and thus improving the test quality.

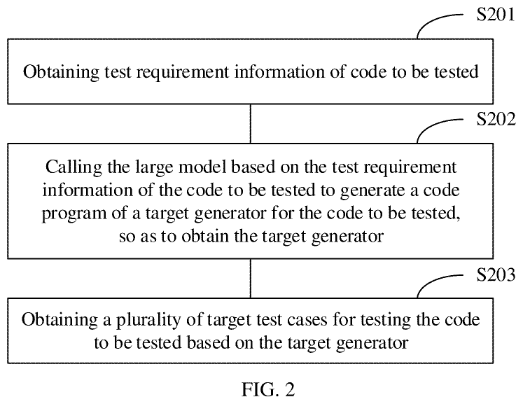

FIG. 2 is a second schematic flowchart of a method for generating a test case based on a large model according to an example of the present application. This method is optionally applied in electronic devices, such as personal computers, servers, server clusters and other electronic devices. It can be understood that the relevant content of the method shown in FIG. 1 described above may also be applied to this example, and the relevant content will not be repeated in this example.

Further, this method includes at least a part of the following content. As shown in FIG. 2, this method includes:

Step S201: obtaining test requirement information of code to be tested.

Step S202: calling the large model based on the test requirement information of the code to be tested to generate a code program of a target generator for the code to be tested, so as to obtain the target generator.

Step S203: obtaining a plurality of target test cases for testing the code to be tested based on the target generator.

That is to say, the solution of the present disclosure calls the large model and combines the test requirement information of the code to be tested to generate the code program of the target generator of the code to be tested, and then uses the code program to generate the plurality of test cases for the code to be tested.

Here, it should be noted that, compared with the solution of directly using the large model to generate a plurality of test cases, the code program of the target generator generated in the solution of the present disclosure is far lower than the solution of directly generating test cases in terms of the amount of text data and the number of tokens occupied. Therefore, the solution of the present disclosure is more practical and requires the lower cost.

In this way, the solution of the present disclosure makes full use of the reasoning ability of the large model to generate the code program of the target generator that can obtain the test cases. Thus, compared with the method of directly using the large model to generate test cases, the amount of text data of and the number of tokens required by the code program of the target generator generated in the solution of the present disclosure are both less than the amount of text data and the number of tokens required in the case of using the large model to directly generate test cases, thereby saving the reasoning resources of the large model. Moreover, the test cases generated by the code program are easier to optimize and adjust, and are also more suitable for engineering reasoning, thereby providing strong support for subsequent improvement of the test efficiency and test quality of the software code.

Further, in a specific example, the target test cases may be obtained in the following manner; and specifically, the above-described step of obtaining a plurality of target test cases for testing the code to be tested based on the target generator (for example, step S203) may specifically include: controlling the code program of the target generator to run in preset environment and obtaining the plurality of target test cases.

For example, in one example, the code program of the target generator generated by the large model is automatically executed in the preset environment such as sandbox environment, so as to obtain the plurality of target test cases.

Thus, the solution of the present disclosure, after obtaining the code program of the target generator generated by the large model, can automatically execute the code program and obtain the required target test cases. In other words, the solution of the present disclosure can obtain the required test cases without relying on manual execution of the code program, saving the manpower and time costs required for the test case generation process, further improving the generation efficiency of test cases, and thereby providing strong support for the test efficiency and test quality of the software test.

Further, in a specific example, the above-mentioned step of controlling the code program of the target generator to run in the preset environment and obtaining the plurality of target test cases may specifically include: controlling the code program of the target generator to run in the preset environment (such as sandbox environment), and obtaining a plurality of initial test cases for testing the code to be tested; testing the plurality of initial test cases under a preset test condition to obtain a target test result; and determining the plurality of target test cases from the plurality of initial test cases based on the target test result.

That is to say, in one example, after the code program of the target generator generated by the large model is obtained, firstly the code program of the target generator is automatically executed in the preset environment (such as sandbox environment) to obtain a plurality of initial test cases; secondly the plurality of initial test cases obtained are automatically tested under the preset test condition such as the simulation environment of the test environment, to verify each initial test case and obtain the target test result; and finally, test cases that do not meet requirements (for example, obviously not conform to the service logic) are eliminated from the plurality of initial test cases according to the target test result to obtain a plurality of target test cases required for the code to be tested, thus further improving the data quality of the test cases.

It should be noted that, in actual applications, after the plurality of initial test cases are obtained, the plurality of initial test cases may also be classified for intelligent management, providing strong support for subsequent automated test execution and coverage statistics. Here, in actual applications, the initial test cases that meet requirements may also be firstly obtained according to the target test result, and then screening is performed from the initial test cases that meet requirements according to the classification result, and finally the target test cases are screened out, so as to improve the test coverage.

In this way, the solution of the present disclosure can automatically execute the code program of the target generator to obtain the plurality of initial test cases and verify the plurality of initial test cases, thereby obtaining the plurality of target test cases required. The above process can automatically complete the verification and screening of the initial test cases generated by the target generator without relying on manual labor, thereby further improving the generation quality of test cases, and laying the foundation for subsequent improvement of the test quality of the software test.

Further, in a specific example, in order to further optimize the target generator generated by the large model to further improve the quality of the obtained test cases, the solution of the present disclosure may also feed back the target test result obtained by verifying the initial test cases to the large model to further optimize the target generator generated by the large model. For example, in an example, after obtaining the target test result described above, the method further includes: calling the large model based on the target test result and the test requirement information of the code to be tested to generate an optimized target generator, for example, generate a code program of the optimized target generator; and further, obtaining a plurality of optimized target test cases based on the optimized target generator, where a test effect of the optimized target test cases is better than a test effect of the target test cases before optimization.

For example, the code program of the optimized target generator is controlled to run in the preset environment to obtain the plurality of optimized target test cases.

It should be noted that, in one example, the target test result may include test coverage, test failure scenarios, cause analysis content for test failure scenarios, and other information. Therefore, the use of the target test result to optimize the target generator can effectively optimize the final target test cases, thereby providing strong support for the test efficiency and test quality of the software test.

For example, the solution of the present disclosure can also construct a target prompt word based on the target test result and the test requirement information of the code to be tested, and then input the target prompt word into the large model to generate a new target generator (corresponding to the optimized target generator mentioned above), so that the quality and coverage of the test cases generated by the test case generator can be continuously improved.

In this way, the solution of the present disclosure can utilize the automated feedback mechanism to feed back the target test result to the large model timely to optimize the reasoning capability of the large model, thus effectively improving the quality of the target generator generated by the large model, enabling the target generator to generate test cases with high quality and high coverage, and thereby providing strong support for improving the test quality and test efficiency of the software test.

In summary, compared with the existing technologies for generating test cases, the solution of the present disclosure has the following advantages:

1. High generation efficiency: Compared with the method for manually writing test cases, the solution of the present disclosure utilizes the reasoning capability of the large model in combination with the test requirement information to firstly generate the test case generator automatically and then use the test case generator to batch generate the required test cases, thus saving the manpower and time costs required for the test case generation process, and effectively improving the generation efficiency of test cases.

2. Lower cost: Compared with the method for directly using the large model to generate test cases, the solution of the present disclosure occupies fewer resources (such as the number of tokens) of the large model, effectively saving the reasoning resources of the large model, and thereby achieving the goal of obtaining test cases at a low cost.

3. More flexible: Compared with the technology for generating test cases based on templates, the solution of the present disclosure can adjust the generator generated by the large model by adjusting the test requirement information, so as to effectively cope with complex and changing service scenarios.

4. Higher quality of test cases: Compared with other existing technologies for generating test cases, the solution of the present disclosure can automatically test the obtained test cases after obtaining the test cases, to screen out test cases meeting requirements (such as service logic) from the obtained test cases; and can also feed back the automatic test result to the large model to optimize the reasoning capability of the large model, and regenerate the test case generator to obtain new test cases with high quality. In this way, the quality and coverage of the generated test cases can be continuously improved through automatic test and feedback optimization.

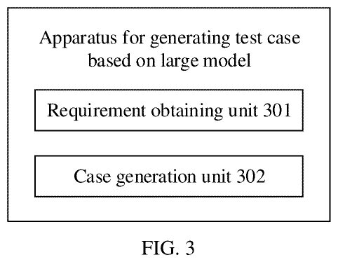

The solution of the present disclosure further provides an apparatus for generating a test case based on a large model, as shown in FIG. 3, including: a requirement obtaining unit 301 configured to obtain test requirement information of code to be tested; and a case generation unit 302 configured to call the large model based on the test requirement information of the code to be tested to generate a target generator for the code to be tested; and obtain a plurality of target test cases for testing the code to be tested based on the target generator.

In a specific example of the solution of the present disclosure, the amount of text data occupied by the target generator is less than the amount of text data occupied by a test case directly generated by the large model.

In a specific example of the solution of the present disclosure, the number of tokens occupied by generating the target generator is less than the number of tokens occupied by the large model to directly generate the test case.

In a specific example of the solution of the present disclosure, the case generation unit is specifically configured to: generate a code program of the target generator for the code to be tested.

In a specific example of the solution of the present disclosure, the case generation unit is specifically configured to: control the code program of the target generator to run in preset environment and obtain the plurality of target test cases.

In a specific example of the solution of the present disclosure, the case generation unit is specifically configured to: control the code program of the target generator to run in the preset environment, and obtain a plurality of initial test cases for testing the code to be tested; test the plurality of initial test cases under a preset test condition to obtain a target test result; and determine the plurality of target test cases from the plurality of initial test cases based on the target test result.

In a specific example of the solution of the present disclosure, the case generation unit is further configured to: call the large model based on the target test result and the test requirement information of the code to be tested to generate an optimized target generator; and obtain a plurality of optimized target test cases based on the optimized target generator, where a test effect of the optimized target test cases is better than a test effect of the target test cases before optimization.

In a specific example of the solution of the present disclosure, the requirement obtaining unit is specifically configured to: parse the code to be tested to obtain a target parsing result; where the target parsing result includes at least one of following code features: a service feature of the code to be tested, a function feature of the code to be tested, and a path feature of an execution path of the code to be tested; and obtain the test requirement information matching a code feature represented by the target parsing result based on the target parsing result.

For the description of specific functions and examples of the units of the apparatus of the example of the present disclosure, reference may be made to the relevant description of the corresponding steps in the above-mentioned method examples, and details are not repeated here.

In the technical solution of the present disclosure, the acquisition, storage and application of the user's personal information involved are in compliance with relevant laws and regulations, and do not violate public order and good customs.

According to the examples of the present disclosure, the present disclosure also provides an electronic device, a readable storage medium and a computer program product.

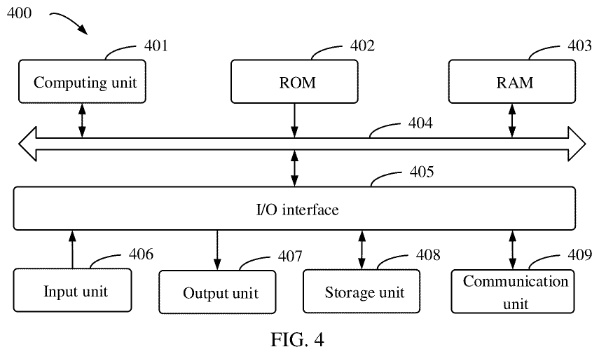

FIG. 4 shows a schematic block diagram of an exemplary electronic device 400 that may be used to implement the examples of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 4, the device 400 includes a computing unit 401 that may perform various appropriate actions and processes according to a computer program stored in a Read-Only Memory (ROM) 402 or a computer program loaded from a storage unit 408 into a Random Access Memory (RAM) 403. Various programs and data required for operations of the device 400 may also be stored in the RAM 403. The computing unit 401, the ROM 402 and the RAM 403 are connected to each other through a bus 404. The input/output (I/O) interface 405 is also connected to the bus 404.

A plurality of components in the device 400 are connected to the I/O interface 405, and include an input unit 406 such as a keyboard, a mouse, or the like; an output unit 407 such as various types of displays, speakers, or the like; the storage unit 408 such as a magnetic disk, an optical disk, or the like; and a communication unit 409 such as a network card, a modem, a wireless communication transceiver, or the like. The communication unit 409 allows the device 400 to exchange information/data with other devices through a computer network such as the Internet and/or various telecommunication networks.

The computing unit 401 may be various general-purpose and/or special-purpose processing components with processing and computing capabilities. Some examples of the computing unit 401 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 401 performs various methods and processes described above, such as the method for generating the test case based on the large model. For example, in some implementations, the method for generating the test case based on the large model may be implemented as a computer software program tangibly contained in a computer-readable medium, such as the storage unit 408. In some implementations, a part or all of the computer program may be loaded and/or installed on the device 400 via the ROM 402 and/or the communication unit 409. When the computer program is loaded into the RAM 403 and executed by the computing unit 401, one or more steps of the method for generating the test case based on the large model described above may be performed. Alternatively, in other implementations, the computing unit 401 may be configured to perform the method for generating the test case based on the large model by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for generating a test case based on a large model, comprising:
obtaining test requirement information of code to be tested;
calling the large model based on the test requirement information of the code to be tested to generate a target generator for the code to be tested; and
obtaining a plurality of target test cases for testing the code to be tested based on the target generator.

2. The method of claim 1, wherein the amount of text data occupied by the target generator is less than the amount of text data occupied by a test case directly generated by the large model.

3. The method of claim 2, wherein the number of tokens occupied by generating the target generator is less than a number of tokens occupied by the large model to directly generate the test case.

4. The method of claim 1, wherein the generating a target generator for the code to be tested, comprises:
generating a code program of the target generator for the code to be tested.

5. The method of claim 4, wherein the obtaining a plurality of target test cases for testing the code to be tested based on the target generator, comprises:
controlling the code program of the target generator to run in preset environment and obtaining the plurality of target test cases.

6. The method of claim 5, wherein the controlling the code program of the target generator to run in preset environment and obtaining the plurality of target test cases, comprises:
controlling the code program of the target generator to run in the preset environment, and obtaining a plurality of initial test cases for testing the code to be tested;
testing the plurality of initial test cases under a preset test condition to obtain a target test result; and
determining the plurality of target test cases from the plurality of initial test cases based on the target test result.

7. The method of claim 6, further comprising:
calling the large model based on the target test result and the test requirement information of the code to be tested to generate an optimized target generator; and
obtaining a plurality of optimized target test cases based on the optimized target generator, wherein a test effect of the optimized target test cases is better than a test effect of the target test cases before optimization.

8. The method of claim 1, wherein the obtaining test requirement information of code to be tested, comprises:
parsing the code to be tested to obtain a target parsing result; wherein the target parsing result comprises at least one of following code features: a service feature of the code to be tested, a function feature of the code to be tested, and a path feature of an execution path of the code to be tested; and
obtaining the test requirement information matching a code feature represented by the target parsing result based on the target parsing result.

9. An electronic device, comprising:
at least one processor; and
a memory connected in communication with the at least one processor;
wherein the memory stores an instruction executable by the at least one processor, and the instruction, when executed by the at least one processor, enables the at least one processor to execute:
obtaining test requirement information of code to be tested;
calling the large model based on the test requirement information of the code to be tested to generate a target generator for the code to be tested; and
obtaining a plurality of target test cases for testing the code to be tested based on the target generator.

10. The electronic device of claim 9, wherein the amount of text data occupied by the target generator is less than the amount of text data occupied by a test case directly generated by the large model.

11. The electronic device of claim 10, wherein the number of tokens occupied by generating the target generator is less than a number of tokens occupied by the large model to directly generate the test case.

12. The electronic device of claim 9, wherein the instruction, when executed by the at least one processor, enables the at least one processor to execute generating the target generator for the code to be tested, by:
generating a code program of the target generator for the code to be tested.

13. The electronic device of claim 12, wherein the instruction, when executed by the at least one processor, enables the at least one processor to execute obtaining the plurality of target test cases for testing the code to be tested based on the target generator, by:
controlling the code program of the target generator to run in preset environment and obtaining the plurality of target test cases.

14. The electronic device of claim 13, wherein the instruction, when executed by the at least one processor, enables the at least one processor to execute controlling the code program of the target generator to run in preset environment and obtaining the plurality of target test cases, by:
controlling the code program of the target generator to run in the preset environment, and obtaining a plurality of initial test cases for testing the code to be tested;
testing the plurality of initial test cases under a preset test condition to obtain a target test result; and
determining the plurality of target test cases from the plurality of initial test cases based on the target test result.

15. A non-transitory computer-readable storage medium storing a computer instruction thereon, wherein the computer instruction is used to cause a computer to execute:
obtaining test requirement information of code to be tested;
calling the large model based on the test requirement information of the code to be tested to generate a target generator for the code to be tested; and
obtaining a plurality of target test cases for testing the code to be tested based on the target generator.

16. The non-transitory computer-readable storage medium of claim 15, wherein the amount of text data occupied by the target generator is less than the amount of text data occupied by a test case directly generated by the large model.

17. The non-transitory computer-readable storage medium of claim 16, wherein the number of tokens occupied by generating the target generator is less than a number of tokens occupied by the large model to directly generate the test case.

18. The non-transitory computer-readable storage medium of claim 15, wherein the computer instruction is used to cause the computer to execute generating the target generator for the code to be tested, by:
generating a code program of the target generator for the code to be tested.

19. The non-transitory computer-readable storage medium of claim 18, wherein the computer instruction is used to cause the computer to execute obtaining the plurality of target test cases for testing the code to be tested based on the target generator, by:
controlling the code program of the target generator to run in preset environment and obtaining the plurality of target test cases.

20. The non-transitory computer-readable storage medium of claim 19, wherein the computer instruction is used to cause the computer to execute controlling the code program of the target generator to run in preset environment and obtaining the plurality of target test cases, by:
controlling the code program of the target generator to run in the preset environment, and obtaining a plurality of initial test cases for testing the code to be tested;
testing the plurality of initial test cases under a preset test condition to obtain a target test result; and
determining the plurality of target test cases from the plurality of initial test cases based on the target test result.
